(19) United States
(12) Patent Application Publication
(10) Pub. No.: US 2004/0159204 A1
(43) Pub. Date: Aug. 19, 2004

(54) Removable nut assembly, methods and kits for stringed musical instruments

(76) Inventor: Floyd D. Rose, Kirkland, WA (US)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 10/759,613

(22) Filed: Jan. 16, 2004

Related U.S. Application Data
(63) Continuation-in-part of application No. 10/341,219, filed on Jan. 13, 2003.
(60) Provisional application No. 60/347,534, filed on Jan. 11, 2002.

(51) Int. Cl. G10D 3/04

(52) U.S. Cl. 84/298

(57) ABSTRACT

A removable nut assembly for stringed musical instruments is disclosed for facilitating release of the tension on the strings to enable disassembly and removal of the strings from the instrument. In certain embodiments, the bridge assembly and the nut assembly of the stringed instrument are readily removable so that an entire set of strings can be quickly removed and replaced. Kits and methods of replacing the strings of a stringed musical instrument are also disclosed.

### CROSS-REFERENCE TO RELATED APPLICATIONS

The present application is a continuation-in-part of U.S. patent application Ser. No. 10/341,219, filed on Jan. 13, 2003 and entitled, “TUNING SYSTEM FOR STRINGED MUSICAL INSTRUMENTS”, which claims the benefit of U.S. Provisional Application serial No. 60/347,534 filed on Jan. 11, 2002, the entire disclosure of which is hereby incorporated by reference.

### BACKGROUND OF THE INVENTION

The present invention relates to stringed musical instruments, such as guitars, and various components thereof. More specifically, the present invention relates to nut assemblies for stringed musical instruments, and in particular, removable nut assemblies, kits and methods for replacing strings of stringed musical instruments.

Conventional guitars and other stringed musical instruments include strings placed under tension, which extend along and above a fretboard mounted on the neck of the instrument. To produce sounds associated with musical notes, the strings are placed in contact with two critical contact points or surfaces. The first critical contact surface is generally at the nut of the instrument, which in the case of a guitar, is usually arranged on the neck adjacent to the first fret of the fretboard. The second critical contact surface is generally provided on or at the bridge of the instrument, which typically is provided on the instrument body beyond an opposing end of the fretboard. The strings are generally fixed to the instrument at a distance beyond the critical contact surfaces at the nut and the bridge.

As is known to those skilled in the stringed musical instrument art, the sound produced by the strings is affected by the harmonic length (i.e., the distance between where the strings contact the critical contact surfaces at the nut and the bridge). Harmonic tuning of the strings is accomplished by adjusting the distance between the critical contact points or surfaces at the bridge and nut on the stringed musical instrument.

The tension of the strings is a second factor that significantly affects the tones generated by the strings during play. String tension may be adjusted by tightening or loosening the strings at the nut or bridge end of the guitar or other musical instrument. Adjustment of the tension in the strings affects the pitch thereof, and thus, such adjustment is commonly known as pitch tuning.

Inventors have made efforts over the years to improve the mounted arrangement of strings with respect to the nut and bridge critical contact surfaces. For instance, in recent years, Floyd Rose, who is the inventor of the present invention, developed string assemblies, which include a string having bullet-shaped anchors secured at both ends thereof. That system is disclosed in U.S. Pat. No. 5,717,150, the disclosure of which is hereby incorporated by reference. The '150 patent also discloses a guitar having a nut assembly and a bridge assembly, wherein a bullet-shaped anchor at one end of each string is secured in a string holder of the nut assembly, and wherein a bullet-shaped anchor at the other end of each string is secured in a corresponding saddle or string holder of the bridge assembly. The guitar and associated strings disclosed in the '150 patent represent substantial improvements over the previous state of the prior art, but there is room for still further improvements in string mounting systems for use with musical instruments, especially those having strings which include an anchor at one or both ends thereof, such as the bullet-shaped anchors disclosed in the '150 patent.

As is known, the structure of the string retention components of stringed musical instruments can make replacement of the strings a difficult process. It can also make tuning the instrument a difficult and time-consuming process. The problems associated with replacing strings and tuning are related, since a stringed musical instrument generally needs to be retuned whenever a string is replaced.

One of the more popular stringed musical instruments is the guitar. Guitars having traditional tuning pegs typically located on the head of the guitar suffer from these types of shortcomings. Such shortcomings have been addressed, in part, by development of new strings and new bridge assemblies that achieve convergent tuning, wherein proper pitch tuning and proper harmonic tuning are substantially simultaneously achieved. One such system is disclosed in the aforementioned U.S. Pat. No. 5,717,150 by Floyd D. Rose. In accordance with the disclosure in the '150 patent, the strings of the instrument are precut and have bullets at both ends of the strings. The bullets at the ends of the strings are held in place in a predetermined fashion by the nut and bridge assemblies on the guitar.

While the guitar and associated strings disclosed in the '150 patent represent substantial improvements over the previous state of the art, existing string retention components used in the nut and bridge assemblies thereof have not resulted in an efficient, easy to use string replacement procedure. Therefore, new systems having improved string retention components are desired to allow for the quick, simple and efficient release and replacement of the strings on a stringed instrument, while still providing an efficient apparatus for tuning of the strings on the instrument. In particular, a need still exists for systems to allow for rapid and efficient release of the strings on the stringed musical instrument and replacement thereof in a simple and efficient manner, and also one that allows for quick and simple retuning of the stringed musical instrument whenever a string or strings are replaced.

### SUMMARY OF THE INVENTION

The present invention overcomes one or more of the shortcomings of the prior art by providing string retention systems, kits and methods that facilitate the rapid replacement of strings and retuning of the instrument. Various mechanisms are disclosed for enabling rapid release of the tension on the strings to enable removal of the strings from the string instrument, including systems and mechanisms for release of the tension on all of the strings secured to the nut assembly, and to even permit removal of the nut and/or the nut assembly from the instrument. In certain preferred embodiments, the nut assembly and the bridge assembly are both removable to facilitate removal and replacement of an entire string assembly of a stringed instrument.

In accordance with one aspect of the present invention, there is provided a removable nut assembly for a stringed musical instrument having an instrument body, a head and at least one string. The nut assembly comprises a nut receiving structure associated with the head end of the instrument, and a nut main body having at least one string holder for securing a first end of a musical instrument string. The nut main body is mountable to the nut receiving structure to secure the nut main body in a position to place the string secured by said at least one string holder under tension and to allow the nut main body to be readily released from the nut receiving structure.

According to one or more embodiments, the nut receiving structure comprises a block mounted to the head end of the instrument. In some embodiments, the block is trapezoidal in cross section, and the nut main body includes a complementary trapezoidal recess formed therein to engage the block. According to certain embodiments, the nut main body is slidably mateable with the block. The nut receiving structure is preferably mounted to the instrument by at least one fastener, such as a screw. Alternatively, the structures could be reversed so that the nut receiving structure includes a trapezoidal recess, the nut main body includes a trapezoidal projection adapted to slidably mate with the recess.

According to another embodiment, the nut receiving structure includes at least one receiving hole formed in the head end of the instrument. In preferred embodiments, the nut receiving structure includes a pair of angled holes in the head end of the instrument. According to these embodiments, the nut assembly may include a pair of protrusions configured to engage the holes and to slidably secure the nut assembly to the instrument.

In accordance with other embodiments, the nut receiving structure includes a pin protruding from the head end of the instrument configured to slidably mate with an opening formed in the nut assembly. Preferably, the pin extends in a direction substantially parallel to the instrument strings. According to one or more embodiments of the invention, the string includes an anchor fastened to one end of the string, and the string holder includes a complementary recess adapted to secure the anchor to the nut main body. In certain embodiments, the anchor and the recess are bullet shaped. In other embodiments, the removable nut may be secured to the guitar by a latching mechanism.

The removable nut assembly of the present invention can be used with various stringed instruments, including guitars. In certain preferred embodiments in which the stringed instrument is a guitar, the guitar includes a bridge releasably mounted to the body end of the instrument in a manner to permit rapid removal of the bridge, the nut main body and the at least one string without detaching the string from the main body or the bridge. In other words, the nut main body, the bridge, and the at least one string can be removed as a single unit, and replaced with another main body, bridge and string unit.

Another embodiment of the invention relates to a stringed instrument comprising a body, a head, and at least one string extending between the head and body and a readily removable nut assembly having at least one string holder releasably secured to the head end of the instrument. In preferred embodiments, a set of strings can be removed from the instrument by removing the readily removable nut from the stringed instrument.

Still another embodiment of the invention relates to a kit for replacing the strings of a stringed instrument comprising a nut assembly including a plurality of string holders, the nut assembly configured to be readily installed and removed on a head end of a stringed instrument, and at least one string. Preferably, the kit further comprises a bridge assembly including a plurality of string holders and a plurality of strings extending between the string holders of the bridge assembly and the string holders of the nut assembly. In preferred embodiments, the strings include string anchors secured to both ends of the strings. And the string holders of the nut assembly and the bridge assembly include complementary recesses for receiving the anchors. In certain embodiments, the anchors are bullet shaped.

According to one or more embodiments relating to a kit, the nut assembly includes a nut receiving structure configured to be mounted to the head end of the instrument, and a nut main body having at least one string holder for securing an end of a musical instrument string, the nut main body being mountable to the nut receiving structure to secure the nut main body in a position to place the string secured by the at least one string holder under tension and to allow the nut main body to be readily released from the nut receiving structure without detaching the strings from the string holders. The nut receiving structure preferably comprises a block configured to be mounted to the head end of the instrument. The block can be trapezoidal in cross section, and the nut main body may include a complementary recess formed therein to engage the block. In preferred embodiments, the nut main body is slidably mateable with the block. The nut receiving structure is preferably mounted to the instrument by at least one fastener.

According to other embodiments related to a kit, the nut receiving structure includes at least one receiving hole formed in the head end of the instrument. In these embodiments, the nut receiving structure preferably includes a pair of angled holes in the head end of the instrument. The nut assembly preferably includes a pair of protrusions configured to engage the holes and to slidably secure the nut assembly to the instrument.

In other embodiments relating to a kit, the nut receiving structure includes a pin protruding from the head end of the instrument configured to slidably mate with an opening formed in the nut assembly. In these embodiments, preferably the pin extends in a direction substantially parallel to the instrument strings. The nut may also be removably secured to the head end of the instrument by a latch that can quickly and easily secure and release the nut.

Another embodiment of the invention relates to a method of changing strings of a stringed instrument comprising removing the strings, a removable nut assembly having a plurality of string holders secured to one end of the strings, and a removable bridge secured to the other end of the strings, without detaching the strings from the string holders. One aspect of the method involves releasing the bridge from the stringed instrument so that the bridge is removable from the instrument. The method may further include removing the nut from a nut receiving structure mounted to the instrument. The strings may include anchors on both ends of the strings, and the string holders of the nut and the bridge have complementary recesses for receiving the anchors. Preferably, the string holders are bullet shaped. The nut assembly, bridge, and strings are preferably removed from the instrument with the strings remaining in the string holders.

According to one or more embodiments, the method further comprises assembling the nut to a nut receiving structure associated with the head end of the instrument, the nut being readily removable from the nut receiving structure. In these embodiments, the nut receiving structure may comprise a block mounted to the head end of the instrument. The block may be trapezoidal in cross section, and the nut includes a complementary recess formed therein to engage the block. The nut can be mounted by sliding the recess over the block. In other embodiments of the method, the nut receiving structure includes at least one receiving hole formed in the head end of the instrument. In these embodiments, the nut receiving structure includes pair of angled holes in the head end of the instrument.

In other embodiments of the method, the nut assembly includes a pair of protrusions configured to engage the holes and to slidably secure the nut assembly to the instrument. In other embodiments of the method, the nut receiving structure includes a pin protruding from the head end of the instrument configured to slidably mate with an opening formed in the nut assembly. In these embodiments, preferably the pin extends in a direction substantially parallel to the instrument strings. In still other embodiments, the nut is secured to the head end of the instrument by a latch, which can be released to remove the nut assembly from the instrument.

The above features of the present invention will be more fully described and understood with reference to the following detailed description of the preferred embodiments of the present invention, when considered in conjunction with the accompanying drawings.

### BRIEF DESCRIPTION OF THE DRAWINGS

FIG. 1 is a perspective view of an electric guitar type of stringed musical instrument, incorporating a string tuning apparatus in accordance with one aspect of the present invention;

FIG. 2 illustrates a set of guitar strings for use with a guitar of the type as shown in FIG. 1;

FIG. 3 is an enlarged exploded perspective view of a removable nut assembly in accordance with one embodiment of the present invention;

FIG. 4 is a partial exploded perspective view the nut assembly shown in FIG. 3 assembled on the head end of a guitar of the type as shown in FIG. 1;

FIG. 5 is an exploded perspective view of the nut assembly shown in FIG. 3, illustrating how the nut assembly is assembled on the head end of a guitar;

FIG. 6 is an exploded perspective view of a removable nut assembly according to another embodiment, illustrating how the nut assembly is assembled on the head end of a guitar;

FIG. 7 is an exploded perspective view of a removable nut assembly according to still another embodiment, illustrating how the nut assembly is assembled on the head end of a guitar;

FIG. 8 is an exploded perspective view of a removable nut assembly according to still another embodiment, illustrating how the nut assembly is assembled on the head end of a guitar;

FIG. 9 is a perspective view of a kit for changing the strings of a guitar type of a stringed musical instrument according to one embodiment of the invention; and

FIG. 10 is a perspective view of kit of the type shown in FIG. 9, illustrating how the kit is assembled on the head end of a guitar.

### DETAILED DESCRIPTION OF THE PREFERRED EMBODIMENTS

Before describing several exemplary embodiments of the invention, it is to be understood that the invention is not limited to the details of construction or process steps set forth in the following description. The invention is capable of other embodiments and of being practiced or carried out in various ways.

Like reference numerals have been used whenever possible to designate like components in the various embodiments of the present invention. Thus, in certain embodiments, various components or features may be designated by different reference numerals, while similar components and features will be designated by the same reference numerals.

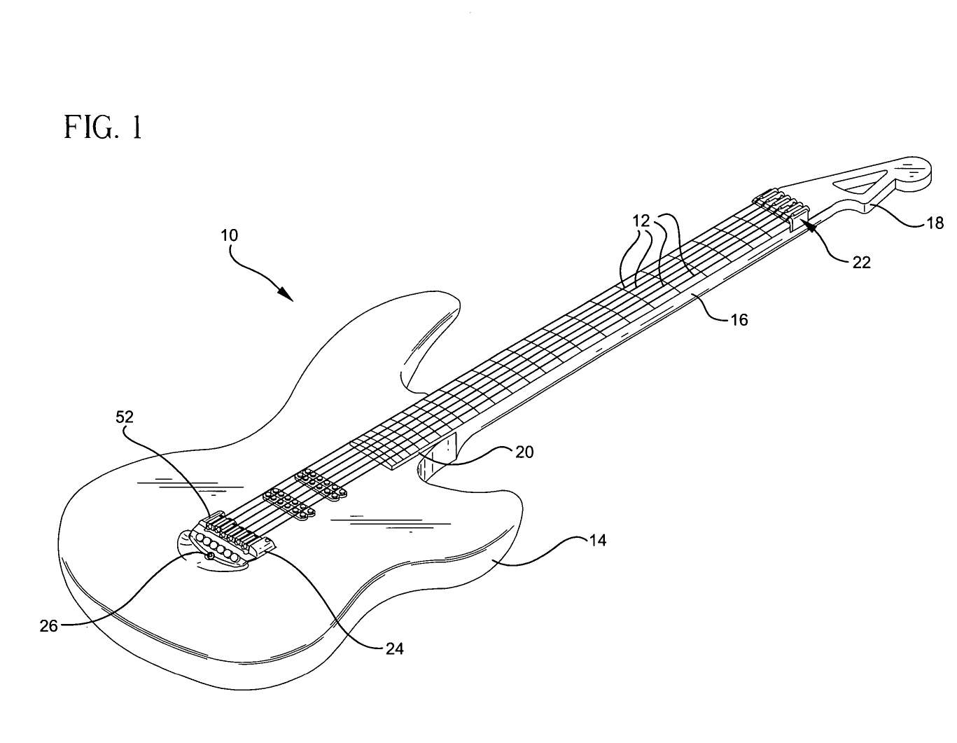

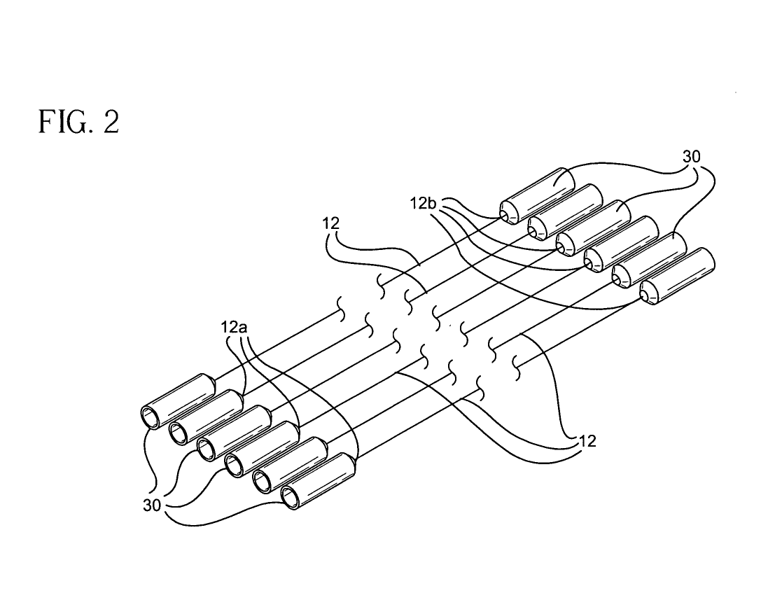

Referring first to FIGS. 1-2 of the drawings, FIG. 1 shows an electric guitar type of stringed musical instrument 10 utilizing a string tuning apparatus in accordance with one aspect of the present invention. While this aspect of the present invention has been employed with respect to an electric guitar 10, it should, however, be appreciated that the present invention can be used in connection with various other types of stringed musical instruments, including, but not limited to acoustic guitars, violins, banjos, and the like, wherein the associated strings 12 need to be retained in place on the instrument 10 and replaced at various times during the life of the instrument.

Although not illustrated in FIG. 1, the electric guitar 10 would typically include all of the normal accessories that can be found on an electric guitar. The guitar 10, as shown in FIG. 1, includes an instrument body 14 and a neck 16 having a head 18. A fretboard 20 is arranged on the neck 16. The fretboard 20 extends between a first end of the neck 16 near the head 18 end of the guitar 10 and a second end of the neck 16, which extends towards the body 14 end of the guitar 10. A plurality of strings 12 are mounted so as to extend between a nut assembly 22 arranged at or near the head 18 and a bridge assembly 24 arranged on the body 14 of the guitar 10. The bridge assembly 24 is preferably secured to the guitar body by a latch mechanism 26 at the rear back edge of the bridge base. Further details on the latch mechanism are described in U.S. patent application Ser. No. 10/341,219, the contents of which are incorporated herein by reference. Note that the guitar 10 does not have tuning pegs on its head 18 since the plurality of strings 12 terminate with the nut assembly 22.

The term “bridge” is often used in the art to only designate the critical contact points or surfaces for the strings. These are the points or surfaces where the guitar strings 12 actually contact corresponding bridge elements. However, it should be appreciated that the terms “bridge” or “bridge assembly”, as used herein, include more than just the critical contact points or surfaces. In particular, the term “bridge assembly” is used to refer to the entire assembly having the critical contact points or surfaces and which includes the tuning apparatus or system for the strings 12. Thus, the bridge assembly 24 includes various other components.

Similarly, the term “nut” is often used in the art to only designate the critical contact points or surfaces for the strings. These are the points or surfaces where the guitar strings 12 actually contact corresponding nut elements. However, it should be appreciated that the terms “nut” or “nut assembly”, as used herein, include more than just the critical contact points or surfaces. In particular, the term “nut assembly” is used to refer to the entire assembly having the critical contact points or surfaces and which includes the main body 32 and tuning apparatus or system for the strings 12. Thus, the nut assembly includes various other components.

The plurality of strings 12 is illustrated in greater detail in FIG. 2. Six guitar strings 12 are illustrated. Each of the guitar strings 12 has a first end 12a and a second end 12b. Bullets 30 or other string anchors are attached to each of the guitar strings 12 at the first end 12a, and bullets 30 or other string anchors are attached to each of the guitar strings 12 at the second end 12b. The bullets 30 on the first ends 12a of the guitar strings 12 are to be retained in place on the guitar 10 by components on the bridge assembly 24, and the bullets 30 on the second ends 12b of the strings 12 are to be retained in place by components in the nut assembly 22. Of course, the ends of the strings 12 can be reversed in the nut assembly 22 and the bridge assembly 24. Strings with bullets on their ends are shown and described in U.S. Pat. No. 5,717,150; U.S. Pat. No. 6,111,176; and U.S. Pat. No. 6,137,039, each of which is hereby incorporated by reference.

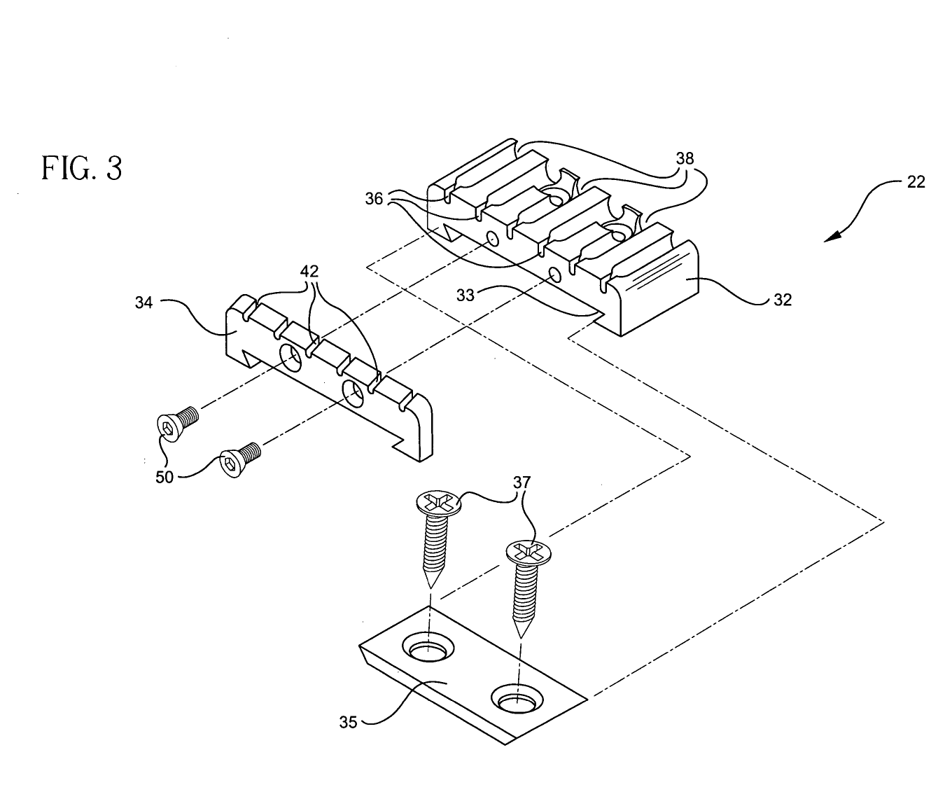

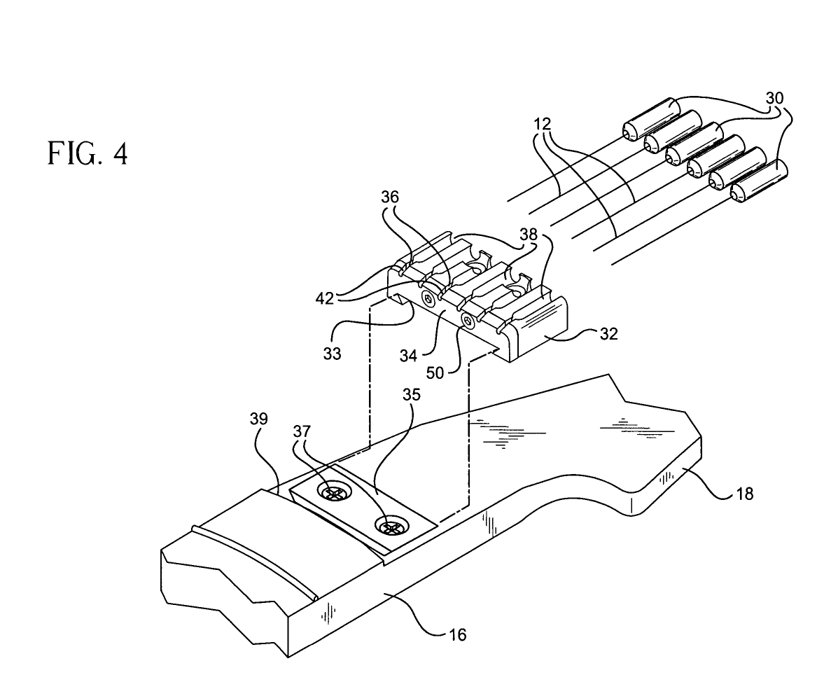

The nut assembly 22 is illustrated in greater detail in FIGS. 3 to 5. The nut assembly includes a main body 32 and a contact plate 34 containing critical contact surfaces for the strings. The main body 32 is adapted to hold the strings of the stringed musical instrument as will be described in more detail below. In the embodiment shown, the main body 32 and contact plate 34 are shown as two separate pieces. It will be understood, however, that the main body 32 and the contact plate 34 can be integrated into a single unit. The main body 32 has six narrow channels 36 at its forward end for the six guitar strings 12 and six wider, bullet-shaped cavities 38 therebehind for receipt of the bullets 30 on the ends 12b of the guitar strings 12. The main body 32 and/or the contact plate 34 are removably secured to the neck 16 of the guitar 10 by a nut receiving structure 35 associated with the head end of the instrument. Fastening elements, for example, screws 37, secure the nut receiving structure 35 to the head end of the instrument. As can be seen by FIG. 3, the nut main body 32 is mountable to the nut receiving structure 35 to secure the nut main body in a position to place the string secured by said at least one string holder under tension and to allow the nut main body to be readily released from the nut receiving structure. As shown in FIG. 4, preferably the contact plate 34 has six channels 42 for the guitar strings 12. Each of the six narrow channels 36 in the main body 32 align with the channels 42 in the contact plate 34 to provide a path for the respective guitar strings 12.

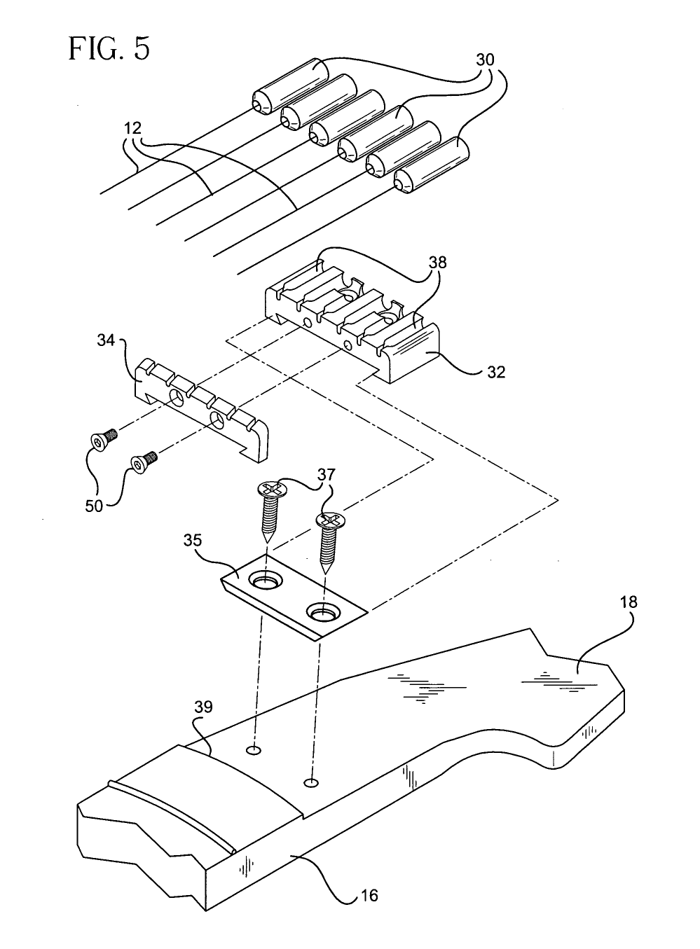

Referring to FIGS. 4 and 5, each of the bullet shaped cavities 38 has an open end 44 at the rear of the main body 32. Each of the cavities 38 receives one of the bullets 31, respectively, on one of the respective guitar strings 12. It is preferred that each of the bullet-shaped cavities 38 be cylindrical, because the bullets 30 are preferably cylindrical. In general, it is preferred that the shape of the cavities 38 match the shape of the bullets 30. It is also preferred that the ends of the cavities 38 nearer to the narrow channels 36, respectively, be contoured to match the ends of the bullets 30 that are attached to the strings 12. The similar shaping of the bullets 30 and the cavities 38 results in each of the bullets 30 fitting into its respective cavity 38 in a snug fit. The snug fit prevents the guitar strings 12 from being affected by any undue motion of the bullets 30 while the guitar 10 is being played.

When a new string 12 is being placed in between the main body 32 of the nut assembly 22 and the bridge assembly 24, the bullet 30 on the string 12 is preferably inserted, string-end first, into the open end 44 of the cavity 38 at the rear of the main body 32. The string 12 is placed through the narrow channel 36 at the forward or front end of the main body 32 and through the channel 42 in the nut contact plate 34. The string 12, when so assembled, is in contact with the channel 42 in the nut contact plate 34. The channel 42 thereby provides a critical contact point or surface for the string 12. The critical contact point or surface is sometimes called a termination point, and represents the point or surface at which a string 12 contacts the nut assembly 22. A similar critical contact point or surface is also provided for the string 12 on the bridge assembly 24. It is well known that the critical contact point or surface at both ends of the strings 12 is important in tuning the guitar 10. Each of the channels 42 in the nut contact plate 34 provides a critical contact point or surface for the strings 12, respectively.

When the bullets 30 are inserted into the respective cavities 38, a portion of the bullets 30 can protrude from the respective open ends 44 at the rear of the main body 32. This may simplify the removal of the bullets 30 from the respective cavities 38 when a string 12 is to be replaced.

The main body 32 and the nut contact plate 34 are preferably constructed from aluminum. They can also be constructed from steel, or from potted metal zinc alloy (ZMAC), or from many other materials.

In the embodiment shown in FIGS. 3 through 5, the nut receiving structure 35 comprises a block mounted to the head end of the instrument, and the block is trapezoidal in cross section. The nut assembly 22, and more particularly, the nut contact plate 34 and the main body 32 include a complementary recess 33 formed therein to engage the block of the nut receiving structure 35. It will be understood that these structures could be reversed. That is, the nut receiving structure 35 could have a recess adapted to receive a mounting surface associated with the nut assembly 22. For example, the nut receiving structure 35 could include a recess that is trapezoidal in cross section, and the nut assembly could include a surface that can slidably fit in the trapezoidal recess. Other variations in the shape of the complementary receiving surfaces are possible. The nut assembly 22 including the contact plate 34 is shown as being slidably mateable with the block. A ledged surface 39 formed in the head end of the instrument adjacent the fretboard provides a stop to lock the nut assembly 22 in a desired position. In the embodiment shown, the removable nut assembly 22 can be slid onto the nut receiving structure 35 in only one direction, substantially parallel to the direction of the strings. However, it will be understood that the block and nut assembly could be configured so that the nut assembly 22 is slid perpendicularly with respect to the direction of the strings. In this case, a stop or other structure could be provided to ensure the nut assembly 22 is properly aligned on the head end of the instrument. In another variant, instead of slidably fitting the nut assembly 22 on the guitar, the nut assembly 22 could be snap fit onto the guitar using appropriate snap fitting components on the nut and the guitar.

The nut contact plate 34 can be fastened to the main body 32 by one or more fasteners such as screws 50. It will be understood that other fasteners could be used to fasten the nut contact plate 34 to the main body 32. Alternatively, no fasteners are used, and the tension of the strings hold the nut contact plate 34 in contact with the main body 32 when the strings are assembled between the bridge and the nut assembly 22 as will be described in more detail below.

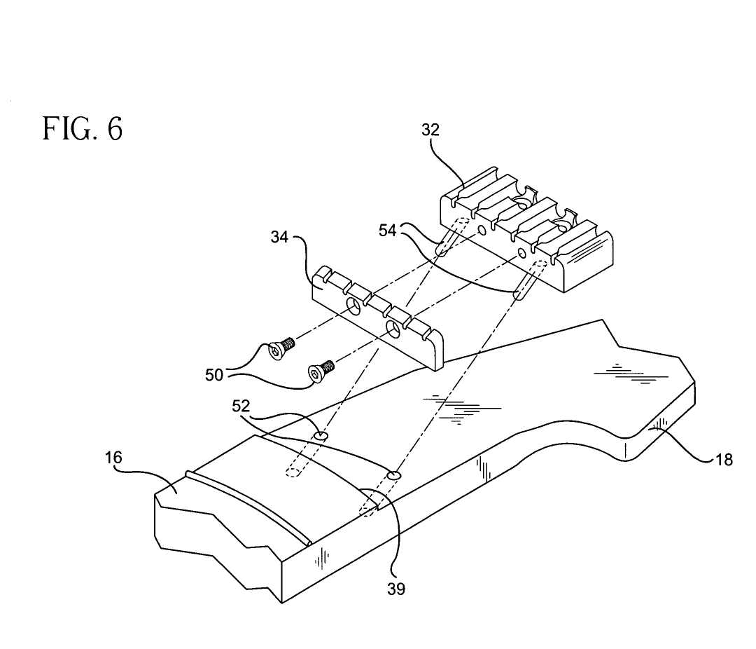

In an alternative embodiment shown in FIG. 6, the nut receiving structure includes at least one receiving hole 52 formed in the head end of the instrument. In a preferred aspect of this embodiment, a pair of angled holes 52 in the head end of the instrument. Still referring to FIG. 6, the nut assembly 22, and more specifically, the main body 32 includes a pair of protrusions 54 configured to engage the holes 52 formed in the head of the instrument and to slidably secure the nut assembly 22 to the instrument 10. The nut assembly 22, including the nut contact plate 34 and the string holder are slid into place and ledged surface 39 acts as a stop to prevent the nut assembly 22 from moving past its desired position on the head end of the instrument 10.

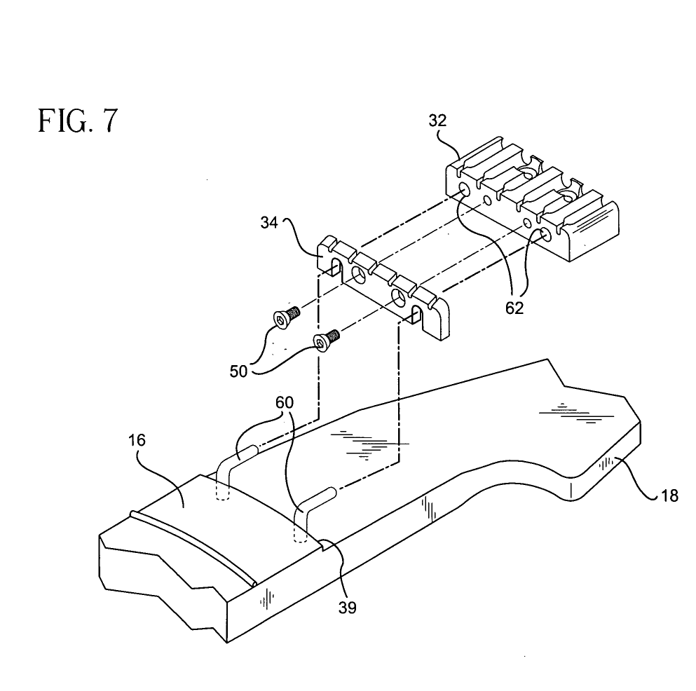

In still another alternative embodiment, shown in FIG. 7, the nut receiving structure includes at least one pin 60 protruding from head end of the instrument configured to slidably mate with at least one opening 62 formed in the nut assembly 22, and in particular, both the nut contact plate 34 and the main body 32. Preferably, the nut receiving structure includes a pair of angled pins 60 protruding from the head end of the instrument. In the embodiment shown in FIG. 7, at least a portion of the pin extends in a direction substantially parallel to the instrument strings. The nut assembly 22, including the nut contact plate 34 and the main body 32 are slid into place, and ledged surface 39 acts as a stop to prevent the nut assembly 22 from moving past its desired position on the head end of the instrument 10.

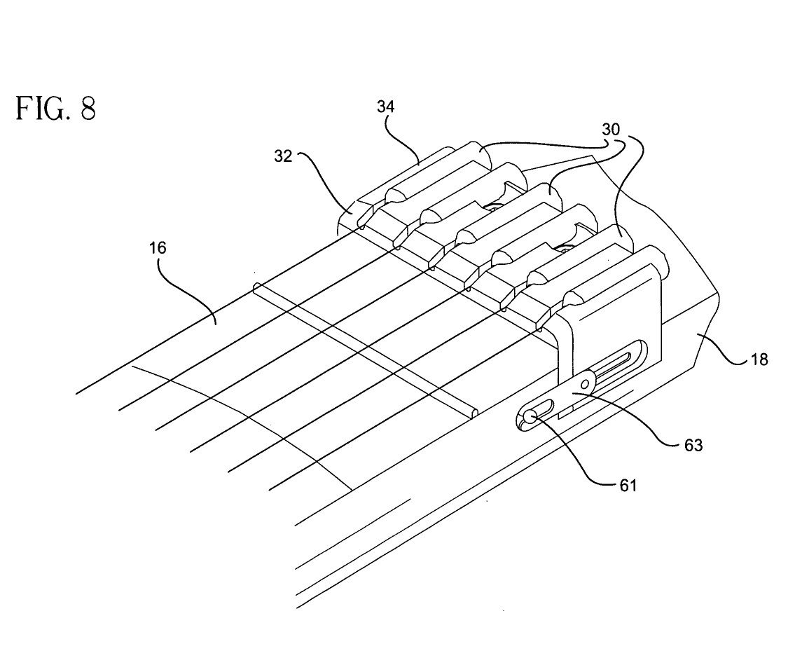

In yet another embodiment, a latch mechanism could be used to secure the nut main body to the guitar head end 18. One example of a latch mechanism is shown in FIG. 8. In the embodiment shown, a first latch component 61 is associated with the head end 18 of the guitar, and a second latch component 63 is associated with the nut assembly 22. In the embodiment shown, the second latch component 63 slidably mates with the first latch component 61, which is shown as a post type structure. Variants on the latch mechanism, include but are not limited to associating the post type structure with the nut main body 22 and associating the sliding latch component with the head end 18 of the guitar. Other latch mechanisms could be used, including but not limited to pawl latches, compression latches, swing latches and the like.

In the embodiments shown and discussed above with respect to FIGS. 1-8, it will be appreciated that the nut assembly 22 is readily removable from the stringed instrument. In certain preferred embodiments, the nut assembly 22 is used with a guitar and together with a removable bridge assembly. Removable bridge assemblies are shown and described in co-pending U.S. patent application Ser. No. 10/341,219, the contents of which are incorporated herein by reference. In certain preferred embodiments, the guitar includes a removable nut assembly 22 and removable bridge assembly to permit removal of the bridge, the nut main body and the at least one string from the body of the instrument, while the string(s) remain in the bridge and the nut.

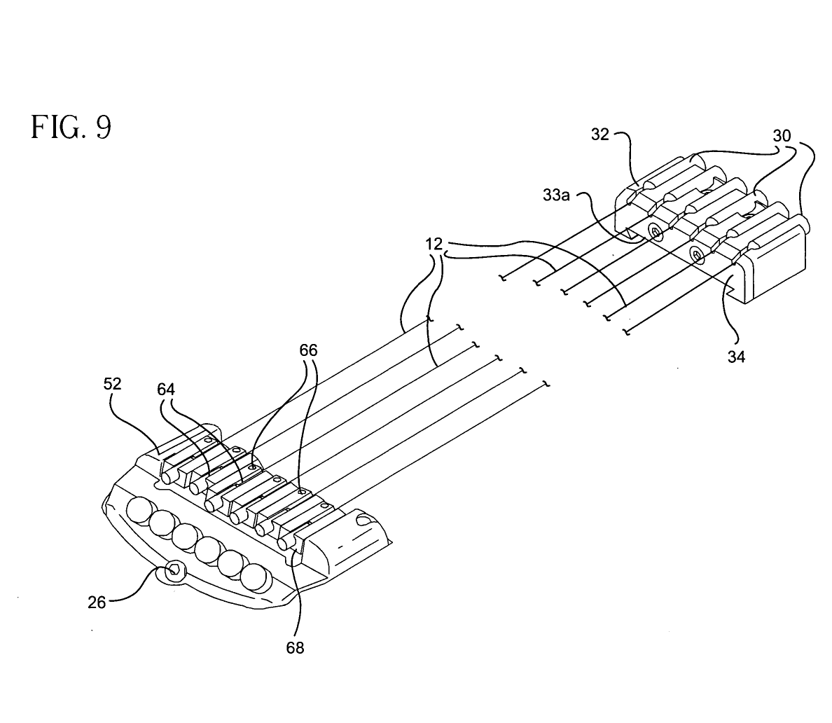

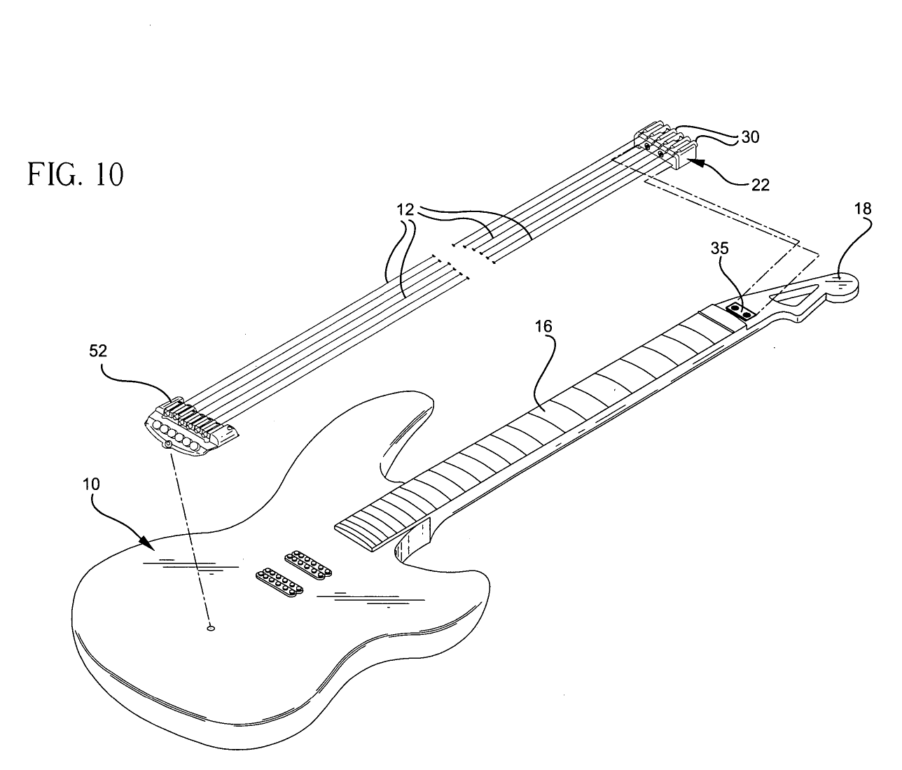

Referring now to FIGS. 9 and 10, a kit for replacing the strings of a stringed musical instrument is shown. The kit comprises a nut assembly 22 including a plurality of string holders associated with a main body 32, the nut assembly 22 configured to be readily installed to and removed from a head end of a stringed instrument. According to certain embodiments, the kit may further comprise a bridge assembly 24 including a plurality of string holders, the bridge assembly including a plurality of string holders.

It is further noted that the bridge assembly 24 illustrated in the figures can be used with a variety of nut assemblies, and the nut assemblies illustrated in the figures can be used with a variety of bridge assemblies, in addition to the one described herein. Still further, various components of the bridge assembly 24 can be used with a variety of other types of bridge assemblies, such as fixed bridge assemblies for electric guitars, as well as acoustic guitars.

As shown and described in co-pending U.S. patent application Ser. No. 10/341,219, the bridge assembly 24 includes a bridge base 52 having a plurality of individually adjustable, string holder assemblies 64 supported thereon for securing the ends of strings 12 on the bridge assembly 24. As more fully described and shown in U.S. patent application Ser. No. 10/341,219, each string holder assembly 64 can be sliding or pivotal with respect to the guitar body. In addition, as noted in U.S. application Ser. No. 10/341,219, certain components of the bridge assembly may preferably be made of aluminum. However, they can also be made from steel or potted metal zinc alloy (ZMAC), or can be made from any of many different materials commonly used for bridge assemblies and components for stringed musical instruments.

According to one or more kit embodiments, a plurality of strings 12 extending between the string holders of the bridge assembly 24 and the string holders of the nut assembly 22, and the strings 12 include string anchors 30 secured to both ends of the strings. As in the embodiments described above, the string holders of the nut assembly and the bridge assembly include complementary recesses for receiving the anchors, and preferably, the anchors are bullet shaped. At least a portion of the nut assembly 22 cooperates with a nut receiving structure 35 configured to be mounted to the head end of the instrument. The nut assembly includes a nut main body 32 having at least one string holder for securing an end of a musical instrument string, and the nut main 32 body is mountable to the nut receiving structure to secure the nut main body in a position to place the string secured by said at least one string holder under tension and to allow the nut main body to be readily released from the nut receiving structure. It will be appreciated that while the nut receiving structure comprises a block configured to be mounted to the head end of the instrument of the type shown in FIG. 3, other nut receiving structures could be utilized, including but not limited to the nut receiving structures shown in FIGS. 6-8. The kits of the present invention can be used to provide removable bridge, nut and string assemblies to facilitate rapid replacement of the strings of a stringed instrument. Such kits are useful for changing the tuning and/or pitch of the strings of a musical instrument without having to perform a separate step of tuning any strings. Thus, a set of strings 12, a nut assembly 22 and a bridge assembly 24 can be provided in a pre-assembled and pre-tuned kit to provide for rapid string replacement and tuning of a stringed musical instrument. One advantage of such a kit is that a musician does not have to purchase numerous guitars or carry or transport numerous guitars to a location at which the guitar will be played. Instead, musician can purchase one guitar, and a plurality of pre-tuned and pre-assembled kits of the present invention, which can be readily removed and installed on a guitar.

Thus, the kits facilitate the provision of different sets of strings having different sound effects. A plurality of string sets, each having different sound effects can be used for rapidly changing the string sets of a guitar in the event that one or more strings of the instrument breaks. Conveniently, instead of having to store and transport numerous guitars, a musician could have fewer guitars on hand and a plurality of different sets of strings that could be rapidly changed out to provide an instrument capable of producing different sound effects.

One or more embodiments of the invention provides a method of changing strings of a stringed instrument comprising removing the strings, a removable nut having a plurality of string holders secured to one end of the strings, and removable bridge secured to the other end of the strings. The strings, nut and bridge are removed together from the instrument while the strings remain associated with the bridge and nut. In certain embodiments, the nut assembly 22, including the nut contact plate 34 and main body 32 of the nut assembly, are readily removable. Removal of the strings can be accomplished by releasing the bridge from the stringed instrument so that the bridge can be removed from the instrument. The method further includes removing the nut contact plate 34 from a nut receiving structure mounted to the instrument. Thus, the nut assembly, the strings 12 and the bridge assembly can be readily removed from the instrument without detaching the strings from the string holders.

The present invention may be used with various types of tremolo apparatus, including but not limited to those disclosed in U.S. Pat. No. 4,549,461, U.S. Pat. No. 4,497,236 and U.S. Pat. No. 4,967,631. Also, it should be appreciated that the removable nut assemblies 22 and the associated structures as described above, can be used on bridge assemblies that do not include a tremolo apparatus.

Installation of a set of strings 12 can be accomplished by engaging a nut assembly with a nut receiving structure, for example, by sliding the nut assembly pre-assembled with a set of strings 12 onto the nut receiving structure. The removable bridge assembly, which is also preferably pre-assembled to the set of strings 12, is engaged with the bridge base 52. The bridge assembly is then locked into place as described in U.S. patent application Ser. No. 10/341,219, filed on Jan. 13, 2003.

While the attachment of the nut assembly 22, bridge assembly 24, and the associated components, to the guitar 10 has been described where no tremolo apparatus is used, it should be appreciated that the various aspects of the present invention can easily be used on bridge assemblies where there is a tremolo apparatus. Thus, the connection of the nut assembly 22 and bridge assembly 24 to the guitar 10 illustrated in 4-10 is merely illustrative. The string retention components described herein can be used with a wide variety of bridge assemblies, and can also be provided as retrofit components for various bridge assemblies.

Also, the string retention components illustrated in the bridge assembly 24 can be incorporated in the nut assembly 22. Thus, the string holder assembly 64 along with the associated components that interface with these components described in U.S. patent application Ser. No. 10/341,219, could be provided in the nut assembly. In this case, any removable bridge assembly could be used in connection with the nut assembly that incorporates the string retention components.

While the foregoing description and figures are directed toward preferred embodiments for the present invention, it should be appreciated that numerous modifications can be made to the structure and arrangement of the various components shown and described. Indeed, such modifications may be made in the materials, structure and arrangement of the components of the various nut assemblies in accordance with the present invention. For instance, most of the various components shown and described with particular embodiments can be employed in other of the embodiments. Similarly, the arrangement of various components in particular embodiments to provide particular features and/or advantages could be employed in the other embodiments. All such variations are deemed to be within the scope of the present invention.

Accordingly, although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A nut assembly for a stringed musical instrument, the instrument having an instrument body, a head, and at least one string, said nut assembly comprising:
a nut receiving structure associated with the head end of the instrument,
a nut main body having at least one string holder for securing an end of a musical instrument string, the nut main body being mountable to the nut receiving structure to secure the nut main body in a position to place the string secured by said at least one string holder under tension and to allow the nut main body to be readily released from the nut receiving structure.

2. The removable nut assembly of claim 1, wherein the nut receiving structure comprises a block mounted to the head end of the instrument.

3. The removable nut assembly of claim 2, wherein the block is trapezoidal in cross section.

4. The removable nut assembly of claim 2, wherein the nut main body includes a complementary recess formed therein to engage the block.

5. The removable nut assembly of claim 4, wherein the nut main body is slidably mateable with the block.

6. The removable nut assembly of claim 2, wherein the nut receiving structure is mounted to the instrument by at least one fastener.

7. The removable nut assembly of claim 1, wherein the nut main body includes at least one receiving hole formed in the head end of the instrument.

8. The removable nut assembly of claim 7, wherein the nut receiving structure includes a pair of angled holes in the head end of the instrument.

9. The removable nut assembly of claim 8, wherein the nut assembly includes a pair of protrusions configured to engage the holes and to slidably secure the nut assembly to the instrument.

10. The removable nut assembly of claim 1, wherein the nut main body includes an opening formed therein, and wherein the nut receiving structure includes a pin protruding from the head end of the instrument configured to slidably mate with the opening formed in the nut main body in the nut main body.

11. The removable nut assembly of claim 10, wherein the pin extends in a direction substantially parallel to the instrument strings.

12. The removable nut assembly of claim 1, wherein the at least one string includes an anchor fastened to one end of the string.

13. The removable nut assembly of claim 12, wherein the string holder includes a complementary recess adapted to secure the anchor to the nut main body.

14. The removable nut assembly of claim 13, wherein the anchor and the recess are bullet shaped.

15. The removable nut assembly of claim 1, wherein the nut receiving structure includes a latch mechanism.

16. A guitar including the removable nut assembly of claim 1.

17. The guitar of claim 16, wherein the guitar includes a bridge releasably mounted to the body end of the instrument in a manner to permit removal of the bridge, the nut main body and the at least one string while the at least one string remains affixed to the bridge and the nut main body.

18. A stringed instrument comprising:
a body, a head, and at least one string extending between the head and body;
a readily removable nut assembly having at least one string holder releasably secured to the head end of the instrument.

19. The stringed instrument of claim 18, wherein the instrument is a guitar.

20. The stringed instrument of claim 19, wherein the nut assembly includes at least one string holder.

21. The stringed instrument of claim 20, wherein the nut assembly includes a plurality of string holders to hold a plurality of strings.

22. The stringed instrument of claim 21, wherein the strings include an anchor on the ends thereof.

23. The stringed instrument of claim 22, wherein the nut assembly includes complementary anchor recesses for receiving string anchors therein.

24. The stringed instrument of claim 23, wherein the anchors and the anchor recesses are bullet shaped.

25. The stringed instrument of claim 21, further comprising a removable bridge mounted on the body end of the instrument.

26. The stringed instrument of claim 25, wherein the bridge includes a plurality a string holders, and a plurality of strings extend between the bridge and the nut assembly.

27. The stringed instrument of claim 25, wherein the bridge, the nut assembly and the strings are removable from the instrument while the strings are assembled to the nut assembly and the bridge.

28. The stringed instrument of claim 18, wherein the nut assembly comprises a nut receiving structure associated with the head end of the instrument, and a nut main body having at least one string holder for securing an end of a musical instrument string, the nut main body being mountable to the nut receiving to secure the nut main body in a position to place the string secured by said at least one string holder under tension and to allow the nut main body to be readily released from the nut receiving structure.

29. The stringed instrument of claim 28, wherein the nut receiving structure comprises a block mounted to the head end of the instrument.

30. The stringed instrument of claim 29, wherein the block is trapezoidal in cross section.

31. The stringed instrument of claim 30, wherein the nut main body includes a complementary recess formed therein to engage the block.

32. The stringed instrument of claim 31, wherein the nut main body is slidably mateable with the block.

33. The stringed instrument of claim 28, wherein the nut receiving structure is mounted to the instrument by at least one fastener.

34. The stringed instrument of claim 28, wherein the nut receiving structure includes at least one receiving hole formed in the head end of the instrument.

35. The stringed instrument of claim 28, wherein the nut receiving structure includes a pair of angled holes in the head end of the instrument.

36. The stringed instrument of claim 35, wherein the nut assembly includes a pair of protrusions configured to engage the holes and to slidably secure the nut assembly to the instrument.

37. The stringed instrument of claim 28, wherein the nut receiving structure includes a pin protruding from the head end of the instrument configured to slidably mate with an opening formed in the nut assembly.

38. The stringed instrument of claim 37, wherein the pin extends in a direction substantially parallel to the instrument strings.

39. The stringed instrument of claim 18 wherein the nut assembly includes a latch mechanism.

40. A kit for replacing the strings of a stringed instrument comprising:
a nut assembly including a plurality of string holders, the nut assembly configured to be readily installed to and removed from a head end of a stringed instrument; and
at least one string configured to be inserted in the nut assembly.

41. The kit of claim 40, further comprising a bridge assembly including a plurality of string holders, the bridge assembly including a plurality of string holders.

42. The kit of claim 41, further comprising a plurality of strings extending between the string holders of the bridge assembly and the string holders of the nut assembly.

43. The kit of claim 42, wherein the strings include string anchors secured to both ends of the strings.

44. The kit of claim 43, wherein the string holders of the nut assembly and the bridge assembly include complementary recesses for receiving the anchors.

45. The kit of claim 44., wherein the anchors are bullet shaped.

46. The kit of claim 40, wherein the nut assembly is mountable to a nut receiving structure configured to be mounted to the head end of the instrument, and the nut assembly includes a nut main body having at least one string holder for securing an end of a musical instrument string, the nut main body being mountable to the nut receiving structure to secure the nut main body in a position to place the string secured by said at least one string holder under tension and to allow the nut main body to be readily released from the nut receiving structure.

47. The kit of claim 46, wherein the nut receiving structure comprises block configured to be mounted to the head end of the instrument.

48. The kit of claim 45, wherein the block is trapezoidal in cross section.

49. The kit of claim 48, wherein the nut main body includes a complementary recess formed therein to engage the block.

50. The kit of claim 49, wherein the nut main body is slidably mateable with the block.

51. The kit of claim 46, wherein the nut receiving structure is mounted to the instrument by at least one fastener.

52. The kit of claim 46, wherein the nut receiving structure includes at least one receiving hole formed in the head end of the instrument.

53. The kit of claim 52, wherein the nut receiving structure includes a pair of angled holes in the head end of the instrument.

54. The kit of claim 53, wherein the nut assembly includes a pair of protrusions configured to engage the holes and to slidably secure the nut assembly to the instrument.

55. The kit of claim 46, wherein the nut receiving structure includes a pin protruding from the head end of the instrument configured to slidably mate with an opening formed in the nut assembly.

56. The kit of claim 55, wherein the pin extends in a direction substantially parallel to the instrument strings.

57. The kit of claim 40, wherein the nut includes a latch mechanism to secure the nut to the instrument.

58. A method of changing strings of a stringed instrument comprising removing the strings, removing a removable nut having a plurality of string holders secured to one end of the strings, and removing a removable bridge secured to the other end of the strings without removing the strings from the string holders.

59. The method of claim 58, further comprising releasing the bridge from the stringed instrument so that the bridge is removable from the instrument.

60. The method of claim 59 comprising removing the nut from a nut receiving structure mounted to the instrument.

61. The method of claim 60, wherein strings include anchors on both ends of the strings.

62. The method of claim 61, wherein the string holders of the nut and the bridge have complementary recesses for receiving the anchors.

63. The method of claim 62, wherein the string holders are bullet shaped.

64. The method of claim 60, further comprising assembling the nut to a nut receiving structure associated with the head end of the instrument, the nut being readily removable from the nut receiving structure.

65. The method of claim 64, wherein the nut receiving structure comprises a block mounted to the head end of the instrument.

66. The method of claim 65, wherein the block is trapezoidal in cross section.

67. The method of claim 65, wherein the nut includes a complementary recess formed therein to engage the block.

68. The method of claim 67, wherein the nut is mounted by sliding the recess over the block.

69. The method of claim 65, wherein the nut receiving structure is mounted to the instrument by at least one fastener.

70. The method of claim 65, wherein the nut receiving structure includes at least one receiving hole formed in the head end of the instrument.

71. The method of claim 70, wherein the nut receiving structure includes a pair of angled holes in the head end of the instrument.

72. The method of claim 71, wherein the nut assembly includes a pair of protrusions configured to engage the holes and to slidably secure the nut assembly to the instrument.

73. The method of claim 65, wherein the nut receiving structure includes a pin protruding from the head end of the instrument configured to slidably mate with an opening formed in the nut assembly.

74. The method of claim 73, wherein the pin extends in a direction substantially parallel to the instrument strings.

75. The method of claim 58, further comprising releasing a latch mechanism associated with the nut.
